(19) United States
(12) Patent Application Publication
(10) Pub. No.: US 2026/0301017 A1
(43) Pub. Date: Oct. 1, 2026

(54) INTEGRATION SYSTEM FOR PROVIDING INTEROPERABILITY OF LOYALTY PROGRAMS OF AN ISSUING RETAILER AND A FUEL RETAILER, A METHOD OF PROVIDING INTEROPERABILITY OF LOYALTY PROGRAMS OF AN ISSUING RETAILER AND A FUEL RETAILER

(71) Applicant: nData Services, Inc., Centennial, CO (US)

(72) Inventors: Samuel Jonas, Centennial, CO (US); Henry R. Nichols, McLean, VA (US)

(21) Appl. No.: 19/632,323

(22) Filed: Mar. 29, 2026

Related U.S. Application Data
(60) Provisional application No. 63/779,820, filed on Mar. 28, 2025.
(60) Provisional application No. 63/780,184, filed on Mar. 29, 2025.

(51) Int. Cl. G06Q 30/0226

(52) U.S. Cl. CPC G06Q 30/0227

(57) ABSTRACT

There is disclosed an integration system for providing interoperability of loyalty programs of an issuing retailer and a fuel retailer. In an embodiment, the system includes an integration system server operably connected to an integration system database. An issuing retailer loyalty program server is operably connected to an issuing retailer loyalty program database. The issuing retailer loyalty program server is configured to communicate with the integration system server using commercially available unmodified point-of-sale hardware and software systems. A fuel retailer loyalty program server is operably connected to a fuel retailer loyalty program database. The fuel retailer loyalty program server is configured to communicate with the integration system server using commercially available unmodified point-of-sale hardware and software systems. Other embodiments are also disclosed.

### REFERENCE TO PENDING PRIOR PATENT APPLICATION

This application claims the benefit under 35 U.S.C. 119 (e) of (1) pending prior U.S. patent application Ser. No. 63/779,820, filed Mar. 28, 2025 by Samuel Jonas for SYSTEM AND METHOD FOR PROVIDING LOWER COST RETAINER GAS REWARDS, and (2) pending prior U.S. Patent Application Ser. No. 63/780,184 filed Mar. 29, 2025 by Samuel Jonas for SYSTEM AND METHOD FOR PROVIDING LOWER COST RETAINER GAS REWARDS.

The above-identified patent applications are hereby incorporated herein by reference.

### BACKGROUND

Grocery stores offer discounted fuel purchases (“fuel rewards”) to their loyalty members through closed-loop loyalty programs. Members earn discounted fuel purchases when they buy certain items, certain volumes of purchases, during a specific time frame, or for other reasons. The discounted fuel purchases are only available at fueling stations affiliated with the grocery store. These discounted vehicle fuel (gas, diesel, etc.) rewards are consistently reported to be the most popular loyalty reward. They provide an incentive for consumers to continue shopping at their grocery store and buy fuel at the affiliated fuel stations. Many of these programs allow consumers to use their phone number as a unique identifier to participate in the loyalty program. However, too often, only the largest of retailers, or those with the most sophisticated technological capabilities—whether as an issuer or a redeemer of the fuel rewards—are able to offer these types of programs.

Currently, a general retailer (grocery, drug, mass merchant) cannot participate in a fuel rewards program. If they wanted to create a program, they would need to contract with a fuel retailer and then require the fuel retailer to modify their software and/or hardware to accommodate the additional steps of linking the two systems, or they would have to build fueling capacity on site. These requirements sharply limit the number of general retailers who can participate in current discount per gallon (DPG) programs.

Existing systems universally employ a system where the gas pumps have been modified to “rollback” the price of a gallon of gas—a discount per gallon (DPG)—and the POS system has been modified to capture and track that DPG. These required technological upgrades also limit the number of fuel retailers who can provide the DPG technological capabilities required to participate as redeemers in current programs.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an embodiment, there is provided an integration system for providing interoperability of loyalty programs of an issuing retailer and a fuel retailer, the system comprising an integration system server operably connected to an integration system database; an issuing retailer loyalty program server operably connected to an issuing retailer loyalty program database, and the issuing retailer loyalty program server is configured to communicate with the integration system server using commercially available unmodified point-of-sale hardware and software systems for providing interoperability of the loyalty programs of the issuing retailer and the fuel retailer; and a fuel retailer loyalty program server operably connected to a fuel retailer loyalty program database, and the fuel retailer loyalty program server is configured to communicate with the integration system server using commercially available unmodified point-of-sale hardware and software systems for providing interoperability of the loyalty programs of the issuing retailer and the fuel retailer.

In another embodiment, there is provided a computer-implemented method of providing interoperability of loyalty programs of an issuing retailer and a fuel retailer, the method comprising operably connecting an integration system server to an integration system database; operably connecting an issuing retailer loyalty program server to an issuing retailer loyalty program database; facilitating communication between the issuing retailer loyalty program server and the integration system server using commercially available unmodified point-of-sale hardware and software systems; operably connecting a fuel retailer loyalty program server to a fuel retailer loyalty program database; and facilitating communication between the fuel retailer loyalty program server and the integration system server using commercially available unmodified point-of-sale hardware and software systems for providing interoperability of the loyalty programs of the issuing retailer and the fuel retailer.

In yet another embodiment, there is provided a non-transient computer readable medium containing program instructions for causing a computer to perform the method of operably connecting an integration system server to an integration system database; operably connecting an issuing retailer loyalty program server to an issuing retailer loyalty program database; facilitating communication between the issuing retailer loyalty program server and the integration system server using commercially available unmodified point-of-sale hardware and software systems; operably connecting a fuel retailer loyalty program server to a fuel retailer loyalty program database; and facilitating communication between the fuel retailer loyalty program server and the integration system server using commercially available unmodified point-of-sale hardware and software systems for providing interoperability of loyalty programs of an issuing retailer and a fuel retailer.

In still another embodiment, there is provided a system of lowering technology barriers and costs for providing fuel rewards programs, which allows for the building of loyalty for retailers and fuel retailers comprising a system server, coupled to the network, configured to track and store member data and transaction data, communicate via APIs with at least one issuing retailer loyalty program server and at least one fuel retailer server, and communicate with at least one consumer device through at least one application, match transaction information to stored fuel credits, and create financial rewards; at least one issuing retailer loyalty program server, coupled to the network, configured to track and store member data and transaction data, communicate with the system server, communicate with at least one store device, and communicate with at least one consumer device through at least one application; at least one store device, coupled to the network, configured to receive and transmit member transaction data and communicate with the issuing retailer program server; a security server, coupled to the network, configured to communicate with at least one of the system server at least one issuing retailer program server and at least one fuel retailer program server, and securely transmit at least one member unique identifier; at least one fuel retailer loyalty program server, coupled to the network, configured to track and store transaction data, communicate with the system server, communicate with at least one fuel pump, and communicate with at least one consumer device; at least one fuel pump, coupled to the network, and configured to communicate with the fuel retailer loyalty program server; at least one consumer device, coupled to the network, and configured to communicate with at least one of the issuing retailer loyalty program server, the fuel retailer loyalty program server, and the system server via at least one application; and at least one financial account, coupled to the network, and configured to accept financial awards.

Other embodiments are also disclosed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 is a schematic illustration of an exemplary system network for providing interoperability of loyalty programs of an issuing retailer and a fuel retailer.

FIG. 2 is a flow diagram of an exemplary method of providing interoperability of loyalty programs of an issuing retailer and a fuel retailer.

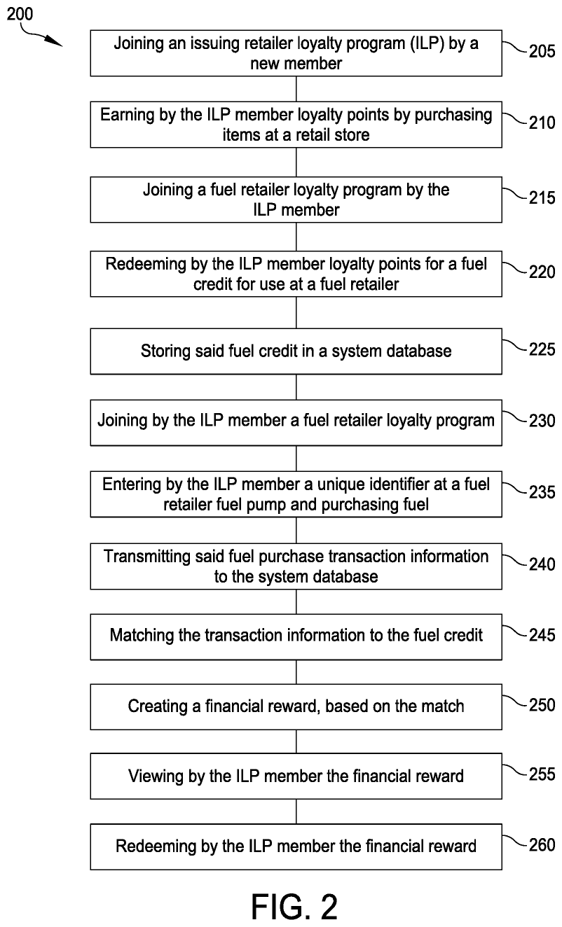

FIG. 3 is a schematic illustration of a flow diagram of another exemplary method of providing interoperability of loyalty programs of an issuing retailer and a fuel retailer.a

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

Loyalty rewards in the form of discounted fuel are almost universally employed with a discount per gallon (DPG) price rollback at the pump. This methodology requires POS hardware and software systems at the pump to be modified and integrated with the retailer systems. For this reason, existing systems are limited to either grocery stores that have their own fueling stations or fuel retailers who have the technical capacity to roll back the price at the pump. Currently, a general retailer (grocery, drug, mass merchant) cannot participate in a fuel rewards program. If one wanted to create a program, one would need to contract with a fuel retailer and then require the fuel retailer to modify their software, or hardware, or both software and hardware, so as to accommodate the additional steps of linking the two systems, or they would have to build fueling capacity on site. These requirements sharply limit the number of general retailers who can participate in current DPG programs.

All of the existing fuel rewards programs require changes to the hardware, software, or both at the point-of-sale and fuel pumps to allow members of the retailer's loyalty programs to receive financial rewards for fuel purchases. Furthermore, current programs are all based upon the discount per gallon model (DPG) where the price per gallon is rolled back, often at varying amounts leaving the shopper unsure what their final savings will be. Various embodiments of the current disclosure create fixed value rewards (for example, a $5 rebate for whatever amount of fuel is purchased). This method allows the consumer to know exactly what their savings will be, while also providing a simpler, lower cost technology option for participating issuing retailers and fuel retailers where the discount is redeemed.

Embodiments provided in the current disclosure do not require any hardware or software changes to the fuel pumps or point-of-sale systems. Embodiments provided in the current disclosure reduce the cost and complexity inherent in the current methods of providing fuel rewards programs and any fuel discounts or financial credits.

Embodiments provided in the current disclosure offer an existing service to new participants, who otherwise cannot participate in offering fuel rewards to loyalty customers. Convenience stores and other fuel retailers that operate fueling stations want to build or increase membership in loyalty programs for their customers. Independent grocery stores, retail drug stores, and other retailers who do not have affiliated fueling stations want to provide additional incentives for their customers to join their loyalty programs and to continue shopping at their retail stores. Embodiments provided in the current disclosure allow a general retailer, i.e., a grocery, drugstore, mass merchant, who does not own fuel service locations to offer the discounted fuel service to their loyalty members through participating fuel retailers by using embodiments of the present disclosure to link loyalty member shoppers directly to the participating fuel retailers for discounts.

Existing loyalty programs allow the entry of a phone number at the pump for earning points and redeeming points, however, the pump software has been modified, usually at significant expense, to “rollback” (reduce) the price, and the payment software has been modified to calculate that price reduction vs. the original price. Embodiments provided in the current disclosure remove the need for these modifications which are sometimes limited by the software version or versions of the pumps and the payment terminals. Additionally, since there are dozens of types of fuel pumps in the market, when there are hardware changes, or software version upgrades, the current DPG programs usually have to be modified, adjusted or reloaded to operate on the new hardware, or any new software versions.

By lowering deployment costs, embodiments provided in the current disclosure allow the expansion of fuel rewards to more locations, especially in underserved rural or inner-city urban locations, benefiting lower income consumers who do not have the time or resources to access big box retailers who are usually in suburban markets.

An additional benefit of embodiments provided in the current disclosure is the prevention of fraud that is allowed in existing systems. In existing systems, a fraudster can steal a member's DPG by simply entering the member's phone number into the fuel pump prior to a transaction and then receiving the discount per gallon for their purchase. In embodiments provided in the current disclosure, the financial reward can be configured to only be provided to the member, via the member's registered financial account.

An additional benefit of various embodiments of the present disclosure is returning fuel purchase transaction data back to the ILP (Issuing Loyalty Program—i.e. the grocer). Some member data that can be tracked are: 1) member travel patterns, e.g. how often and where does the member refuel; 2) money management behaviors, e.g. does the member use every credit the moment it is issued/available, or is the member a “saver” who banks the their fuel credits and uses them at a later date, for a “rainy day”; and 3) purchase habits, e.g. does the ILM (Issuing Loyalty Member) just buy gas, or do they also shop inside the FLP's (Fuel Loyalty Program) store. The ILP and FLP can share data, building better insights into the member's behaviors to more accurately understand the user.

Convenience stores and other fuel retailers that operate fueling stations want to build or increase membership in loyalty programs for their customers. Independent grocery stores, retail drug stores, and other retailers who do not have affiliated fueling stations want to provide additional incentives for their customers to join their loyalty programs and to continue shopping at their retail stores. The market needs a new technology solution to provide to these retailers and their loyalty members, an option to participate in these popular rewards.

Loyalty programs exist in many forms and names. Some retailers avoid the label “loyalty” and offer “VIP membership” or a “Rewards club” or “Perks”. In each case, they generate premiums for the members of the retailer's proprietary database, which may be generated through points, tiers, milestones, perks and the like. For the purposes of the embodiments provided in the current disclosure, the term “loyalty program” may be used to refer to any of these programs and “points” may be used to describe any of the premiums provided to participating shoppers.

Embodiments provided in the current disclosure provide more efficient systems, methods, and technological solutions that allow independent grocery stores and other retailers to work with fuel retailers to provide a loyalty fuel reward program that allows customers to receive financial rewards for retail purchases combined with fuel purchases.

Embodiments provided in the current disclosure generally relate to apparatus, systems and methods relating to providing retail loyalty program members with financial rewards offered at partner fuel retailer locations. For generalization purposes, grocery stores (herein referred to as simply grocery stores) are a key target retail vertical and issuing retailer loyalty programs (ILP) as the sample loyalty program.

ILP members earn ILP points when they make purchases at the grocery store. While points are typically used for discounted groceries, embodiments provided in the current disclosure allow the ILP members to redeem points for fuel purchases at partner fuel retailers. Points can be converted at a defined conversion ratio, e.g. 100 points=$1. The ILP member has an option to convert points to a fuel credit at a partner fuel retailer. The ILP may have more than one fuel retailer partner in the system. The ILP member may convert the points to a fuel credit via an ILP mobile application, web page, or other method. The fuel credit may utilize a single use symbology like a serialized bar code, or QR code. The fuel credit is securely stored in a system database on a system server. The fuel credit is a specific amount, e.g. $5, not a discount per gallon.

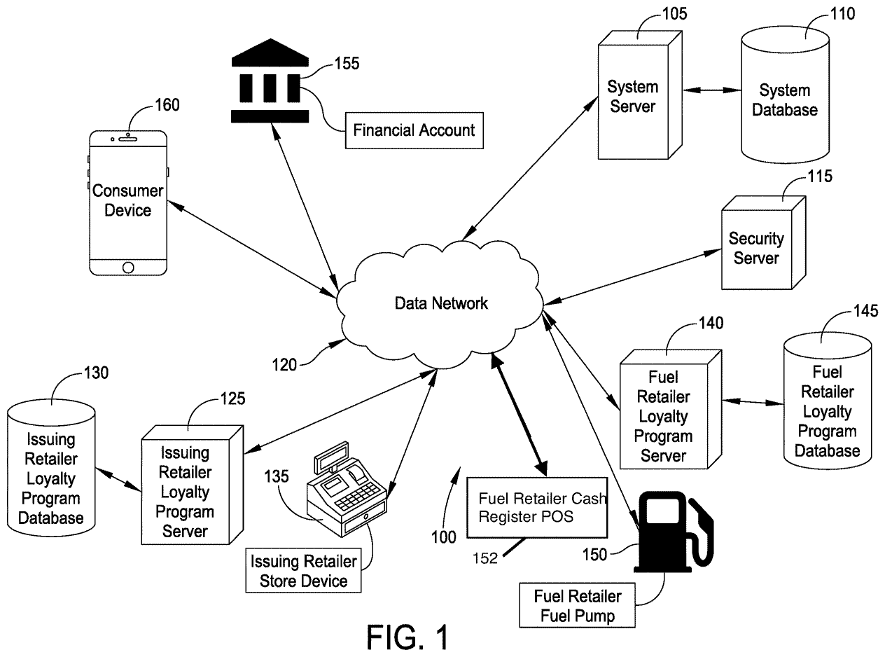

With general reference to FIG. 1, the ILP member information is stored in the system database 130 on the system server 125. ILP member information comprises at least one of the customer's name, phone number, address, a unique identifier (which may be the customer phone number) and at least one ILP member fuel credit.

The system database, ILP database, and FLP database may be connected to a data network, which may be, but is not limited to, the Internet. Data networks used in additional embodiments include local area networks (LANs), wide area networks (WANs), telephone networks, enterprise private networks, virtual private network, peer-to-peer networks, cellular data networks, and other networks. The data network comprises connections to each of the servers, at least on consumer device, and at least one issuing retailer store device.

Current loyalty programs allow the entry of a phone number at the pump for earning points and redeeming points-however, the pump software has been modified, usually at significant expense, to “rollback” (reduce) the price, and the payment software has been modified to calculate that price reduction vs. the original price. Various embodiments of the present disclosure remove the need for these modifications which are sometimes limited by the software version(s) of the pumps and the payment terminals. Additionally, since there are dozens of types of fuel pumps in the market, when there are hardware changes, or software version upgrades, the current DPG programs usually have to be modified, adjusted or reloaded to operate on the new hardware, or any new software versions.

With continuing reference to FIG. 1, embodiments provided in the current disclosure may include an integration system 100 with an integration system server 105 with a system database 110. A security server 115 may be in connection with integration system server 105 either by a direct connection or by a connection through a data network 120 (which may be utilized to indirectly connect various components with one another). Integration system server 105 may be connected to at least one fuel retailer loyalty program (FLP) server 140. A FLP database 145 on the FLP server 140 contains FLP member information comprising at least one of the customer's name, phone number, address, and unique identifier, which may be the customer phone number. The ILP member joins the FLP using the same unique identifier used in the ILP. The FLP receives from the ILP, a list of all ILP member unique identifiers for ILP members who have chosen to convert their loyalty points into a fuel credit.

The FLP includes the feature of unique identifier functionality at each fuel pump 150, which allows the FLP member to be identified. The unique identifier may be entered by hand on a keypad, scanned via an electronic reader, or received via wireless transmission, etc. The FLP has functionality of capturing date, time, location, amount, transaction number, and other transaction related data for each fuel purchase. In some cases, a fuel retailer's pumps can consume a unique identifier, when prompted, and deliver it to a remote host without a loyalty program being present. In these cases, as along as the remote host (mimicking a FLP server) can connect to the system server, then various embodiments provided in the current disclosure can support these fuel retailer locations also.

When the ILP member, who is also a FLP member, enters their unique identifier as part of a fuel purchase, at least one of the fuel pump, the fuel retailer server, and the FLP captures the date, time, location, amount, and transaction number in addition to the unique identifier. This transaction information is sent to the system server and stored in the system database. The transaction information is compared to the ILP member's fuel credit(s), and if there is a match, the system server updates the status of the fuel credit to a financial reward in the system database and sends the status to the ILP. Additionally, the updated status may be sent to the ILP member as one or more of an email message, text message, and app notice.

The ILP member chooses the method of reward and receives the financial reward. The cost of the financial reward may be borne by the issuing retailer, the fuel retailer, or a split between the two. Because there are two participating providers, the financial reward may be larger than a comparable reward from a grocery store with affiliated fueling stations. By sharing user behavioral/purchase data, the ILP and FLP can strengthen their knowledge of their common customer, making them more loyal, increasing their share-of-wallet purchase percentages, and strengthening their respective data analytics.

Embodiments provided in the current disclosure may include a cloud-to-cloud system that requires no changes to point-of-sale or fuel-pump hardware or software. Various embodiments offer a low-cost, flexible, and remotely implemented technology solution to the problem of allowing members of issuing retailer loyalty programs to receive benefits for fuel purchasers at unaffiliated fuel retailers.

In one embodiment, a system 100 is provided. The system 100 may include a data network 120 which is connected to one or more of a system server 105 and database 110, an ILP server 125 and database 130, a fuel retailer fuel pump 150, a fuel retailer cash register point-of-sale (POS), a FLP server 140 and database 145, a consumer device 160, and a financial account 155. The system server 115 may provide and publish a library of public and private APIs to facilitate connectivity between the system server 105 and authorized participants.

In one embodiment, a method (200) may be provided. The method may include joining an issuing retailer loyalty program (ILP) by a new member (205). The method may include earning, by the ILP member, loyalty points by purchasing items at a retailer store device (210). The method may include joining a fuel retailer loyalty program by the ILP member (215). The method may include redeeming, by the ILP member, loyalty points for a fuel credit for use at a fuel retailer (220). The method may include storing said fuel credit in a system database (225). The method may include joining by the ILP member a fuel retailer loyalty program (230). The method may include entering by the ILP member a unique identifier at a fuel retailer fuel pump and purchasing fuel (235). The method may include transmitting said fuel purchase transaction information to the system database (240). The method may include matching the transaction information to the fuel credit (245) and creating a financial reward (250). The method may include viewing by the ILP member the financial reward (255). The method may include redeeming, by the ILP member, the financial reward (260).

In one embodiment, joining an ILP may include providing at least one of a name, and a unique identifier. In an additional embodiment, the unique identifier is a phone number.

In one embodiment, redeeming loyalty points may include selecting from a list of participating fuel retailers, in an ILP application, and selecting a number of points to redeem for a specified fuel credit amount. In an additional embodiment, the ILP application is a mobile application. In an additional embodiment, while selecting a participating fuel retailer, the ILP member may join the participating fuel retailer loyalty program (FLP). In an additional embodiment, the ILP member joins the FLP at a later date. In an additional embodiment, after the member joins the ILP, the system server receives a confirmation from the ILP that the member has successfully joined the ILP. In an additional embodiment, the ILP member may already be a member of the FLP.

In one embodiment the fuel credit may be a unique serialized token.

In one embodiment, the fuel credit may be a specific entry in a secure database.

In one embodiment, the fuel retailer may be at least one of a convenience store, a truck stop, a national fuel chain, an oil company, a co-op fuel retailer, a dealer-owned station, an alternative fuel retailer, and an electric vehicle charging station.

In one embodiment, the integration system database (or system database) may be the ILP database. In an additional embodiment, the integration system database may be a part of the ILP database. In an additional embodiment, the integration system server (or integration server) may be the ILP server. In an additional embodiment the system database may be a separate database operated by a third-party.

In one embodiment the unique identifier may be at least one of a phone number, a member selected number, a randomly generated number, a pseudonymous ID, an anonymous ID, an address, a QR code, a 2D barcode, a vehicle identifier transmitted wirelessly, and a wireless communication between the user's phone and the pump. In an additional embodiment, the unique identifier may be a combination of a member identifier paired with a vehicle identifier.

In one embodiment, the unique identifier is securely transmitted from a secure server to the ILP and the FLP. The secure server generates a pseudonymous or anonymous ID for transmittal throughout the network, which protects the member's phone number or any other personally identifiable information used as a unique identifier. In an additional embodiment, the secure server may be a part of the system server.

In one embodiment, entering the unique identifier may be performed via at least one of manual entry on a keyboard, wireless entry via key fob, wireless entry via a mobile device, scanning of a card, scanning a bar code, scanning a QRC from a phone.

In one embodiment, the transaction information may contain at least one of the transaction amount, date, time, member unique identifier, location, transaction number, fuel pump identifier, # of gallons of fuel purchased, and any other data that would appear on the transaction log for an individual transaction.

In one embodiment, the transmission of the transaction information may be routed from the fuel pump via at least one of directly to the system server, through the fuel retailer server to the system server. In an additional embodiment, the transaction information is routed to the system server by the FLP.

In one embodiment, the matching of the transaction information to the fuel credit may include matching the unique identifier and may include at least one of a fuel retailer identifier, a minimum transaction amount, a defined location, and a minimum # of gallons.

In one embodiment, the viewing of the financial reward may occur in the ILP application.

In one embodiment, the redeeming of the financial reward may be initiated in the ILP application. In an additional embodiment, the redeeming of the financial reward is initiated in the system database.

In one embodiment, the financial reward may be received via funding of at least one of a financial account and a digital wallet. In an additional embodiment, the account may include at least one of a bank account, a non-bank account, a debit card, a pre-paid card, a Venmo account, and a PayPal account. In an additional embodiment, the financial reward may be received via the issuing retailer.

In one embodiment, the financial reward may be a discount applied to a purchase at the grocery store in the ILP program.

In one embodiment, the ILP member may pre-select the delivery of the financial reward, so that immediately upon receipt of transmission of the fuel purchase information, the financial reward is redeemed and sent to the ILP member's financial account.

In one embodiment, the ILP member may pre-select the redemption of loyalty points for a fuel credit, so that when a loyalty points threshold is achieved, the system automatically generates a fuel credit at a specified fuel retailer.

In an additional embodiment, the ILP member may choose to accrue fuel credits and only use them at a future time.

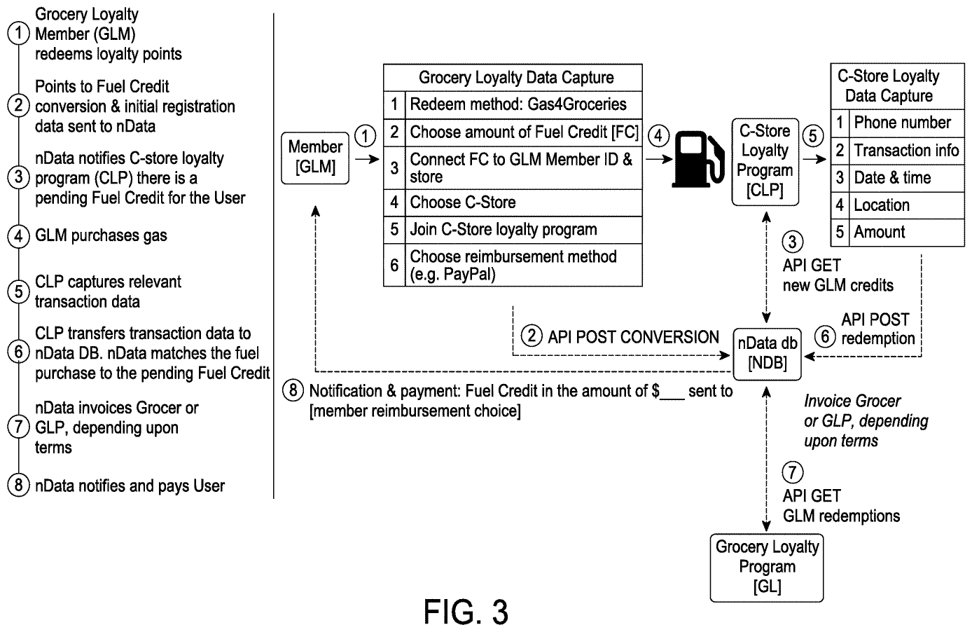

For example, and in accordance with the embodiments of the present disclosure, assume that a consumer enrolls in the loyalty program at a grocery store, using her phone number as the unique identifier. She purchases $500 of groceries. Each dollar of food purchased earns the member 1 point, so she earns 500 points. The conversion ratio for fuel credits is 100 points=$1 fuel credit. The member redeems her 500 points for a $5 fuel credit at Sinclair. Next, the member purchases $45 of fuel at Sinclair, after entering her phone number to begin the transaction. Sinclair, Sinclair's pumps or Sinclair's FLP sends the transaction information to the system server. The system server matches her transaction information to her stored fuel credit and converts the $5 fuel credit to a $5 financial reward. The member receives a notification that she has received the $5 reward. Using her mobile application, she directs the $5 reward to be deposited in her PayPal account. Furthermore, FIG. 3 illustrates a similar sequence in accordance with various embodiments of the present disclosure.

A computer-implemented method of providing fuel rewards programs in order to build loyalty for retailers and fuel retailers may be provided. The method may include receiving at a system server computer, from an issuing retailer loyalty program including at least one server and at least one database of member data coupled to at least one retail store, new member data including a unique identifier. The method may include receiving at the system server computer, from the issuing retailer loyalty program server via APIs, member transaction data may include at least one of purchased UPCs, SKUs, and the member unique identifier. The method may include calculating at the system server loyalty points in the issuing retailer loyalty program determined by the member transaction data. The method may include receiving at the system server a redemption request, from a consumer device coupled to the network, including a determined number of loyalty points and a corresponding fuel credit for use at a designated fuel retailer. The method may include activating, by the system server, the redemption request. The method may include storing, by the system server, the fuel credit for the member in the system database. The method may include receiving, by a fuel loyalty program server coupled to the network, member data comprising at least one of member name and the unique identifier from the issuing retailer loyalty program. The method may include receiving, at a fuel pump coupled to the fuel loyalty program server, the member unique identifier. The method may include receiving, by the system server, fuel purchase transaction information from the fuel pump comprising the member's unique identifier and at least one of transaction amount, fuel volume, fuel type. The method may include matching, by the system server, the fuel purchase transaction information to the stored fuel credit in the system database. The method may include calculating, by the system server, a financial reward based on the match. The method may include storing in the system database the financial reward including the unique member identifier and the amount of the financial reward. The method may include displaying on the consumer device the financial reward. The method may include selecting, by the member on the consumer device, a redemption action for the financial reward. The method may include generating, by the system server, a financial reward digital payment file to a financial account.

There may be provided a system of lowering technology barriers and costs for providing fuel rewards programs, which allows for the building of loyalty for retailers and fuel retailers. The system may include a system server, coupled to the network, configured to track and store member data and transaction data, communicate via APIs with at least one issuing retailer loyalty program server and at least one fuel retailer server, and communicate with at least one consumer device through at least one application, match transaction information to stored fuel credits, and create financial rewards. The system may include at least one issuing retailer loyalty program server, coupled to the network, configured to track and store member data and transaction data, communicate with the system server, communicate with at least one store device, and communicate with at least one consumer device through at least one application. The system may include at least one store device, coupled to the network, configured to receive and transmit member transaction data and communicate with the issuing retailer program server. The system may include a security server, coupled to the network, configured to communicate with at least one of the system server at least one issuing retailer program server and at least one fuel retailer program server, and securely transmit at least one member unique identifier. The system may include at least one fuel retailer loyalty program server, coupled to the network, configured to track and store transaction data, communicate with the system server, communicate with at least one fuel pump, and communicate with at least one consumer device. The system may include at least one fuel pump, coupled to the network, and configured to communicate with the fuel retailer loyalty program server. The system may include at least one consumer device, coupled to the network, and configured to communicate with at least one of the issuing retailer loyalty program server, the fuel retailer loyalty program server, and the system server via at least one application. The system may include at least one financial account, coupled to the network, and configured to accept financial awards.

By lowering deployment costs, embodiments of the current disclosure allow the expansion of fuel rewards to more locations, especially in underserved rural or inner-city urban locations, benefiting lower income consumers who do not have the time or resources to access big box retailers who are usually in suburban markets.

An additional benefit of embodiments of the current disclosure are the prevention of fraud that is allowed in existing systems. In existing systems, a fraudster can steal a member's DPG by simply entering the member's phone number into the fuel pump prior to a transaction and then receiving the discount per gallon for their purchase. In various embodiments of the present disclosure, the financial reward can only be provided to the member, via the member's registered financial account.

An additional benefit of embodiments of the current disclosure are returning fuel purchase transaction data back to the ILP. Some member data that can be tracked are: 1) member travel patterns, e.g. how often and where does the member refuel; 2) money management behaviors, e.g. does the member use every credit the moment it is issued/available, or are they a “saver” who banks the their fuel credits and uses them at a later date-for a “rainy day”; and 3) purchase habits, e.g. does the ILM just buy gas, or do they also shop inside the FLP's store. The ILP and FLP can share data, building better insights into the member's behaviors to more accurately understand the user.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. An integration system for providing interoperability of loyalty programs of an issuing retailer and a fuel retailer, the system comprising:
an integration system server operably connected to an integration system database;
an issuing retailer loyalty program server operably connected to an issuing retailer loyalty program database, and the issuing retailer loyalty program server is configured to communicate with the integration system server using commercially available unmodified point-of-sale hardware and software systems for providing interoperability of the loyalty programs of the issuing retailer and the fuel retailer; and
a fuel retailer loyalty program server operably connected to a fuel retailer loyalty program database, and the fuel retailer loyalty program server is configured to communicate with the integration system server using commercially available unmodified point-of-sale hardware and software systems for providing interoperability of the loyalty programs of the issuing retailer and the fuel retailer.

2. The integration system of claim 1, further comprising an integration security server configured to communicate with, using commercially available unmodified point-of-sale hardware and software systems, at least one of the integration system server, the issuing retailer loyalty program server, and the fuel retailer loyalty program server.

3. The integration system of claim 1, further comprising an issuing retailer store device configured to communicate with, using commercially available unmodified point-of-sale hardware and software systems, at least one of the integration system server, the issuing retailer loyalty program server, and the fuel retailer loyalty program server.

4. The integration system of claim 3, wherein the issuing retailer store device consists of commercially available unmodified point-of-sale hardware and software systems of the issuing retailer store device.

5. The integration system of claim 1, wherein the integration system server is configured to communicate with a financial account of a user using commercially available unmodified point-of-sale hardware and software systems so as to facilitate a transfer of a financial reward from at least one of the integration system server, the issuing retailer loyalty program server, and the fuel retailer loyalty program server to the financial account of the user.

6. The integration system of claim 1, wherein the integration system server is configured to communicate with a consumer device of a user using commercially available unmodified point-of-sale hardware and software systems so as to facilitate a transfer of a financial reward from at least one of the integration system server, the issuing retailer loyalty program server, and the fuel retailer loyalty program server to the financial account of the user.

7. The integration system of claim 6, wherein the consumer device is at least one of a mobile phone, a portable computer tablet, a laptop computer, a desktop computer, or a smart television display system.

8. The integration system of claim 1, further comprising a fuel retailer fuel pump configured to communicate with, using commercially available unmodified point-of-sale hardware and software systems, at least one of the integration system server, the issuing retailer loyalty program server, and the fuel retailer loyalty program server.

9. The integration system of claim 8, wherein the fuel retailer loyalty program server consists of commercially available unmodified point-of-sale hardware and software systems, and the fuel retailer fuel pump consists of commercially available unmodified point-of-sale hardware and software systems.

10. A computer-implemented method of providing interoperability of loyalty programs of an issuing retailer and a fuel retailer, the method comprising:
operably connecting an integration system server to an integration system database;
operably connecting an issuing retailer loyalty program server to an issuing retailer loyalty program database;
facilitating communication between the issuing retailer loyalty program server and the integration system server using commercially available unmodified point-of-sale hardware and software systems;
operably connecting a fuel retailer loyalty program server to a fuel retailer loyalty program database; and
facilitating communication between the fuel retailer loyalty program server and the integration system server using commercially available unmodified point-of-sale hardware and software systems for providing interoperability of the loyalty programs of the issuing retailer and the fuel retailer.

11. The method of claim 10, further comprising, using commercially available unmodified point-of-sale hardware and software systems, providing an integration security server configured to communicate with at least one of the integration system server, the issuing retailer loyalty program server, and the fuel retailer loyalty program server.

12. The method of claim 10, further comprising, using commercially available unmodified point-of-sale hardware and software systems, providing an issuing retailer store device configured to communicate with at least one of the integration system server, the issuing retailer loyalty program server, and the fuel retailer loyalty program server.

13. The method of claim 12, wherein the issuing retailer store device consists of commercially available unmodified point-of-sale hardware and software systems.

14. The method of claim 10, further comprising, using commercially available unmodified point-of-sale hardware and software systems, facilitating communication between the integration system server and a financial account of a user so as to facilitate a transfer of a financial reward from at least one of the integration system server, the issuing retailer loyalty program server, and the fuel retailer loyalty program server to the financial account of the user.

15. The method of claim 10, further comprising, using commercially available unmodified point-of-sale hardware and software systems, facilitating communication between the integration system server and a consumer device of a user so as to facilitate a transfer of a financial reward from at least one of the integration system server, the issuing retailer loyalty program server, and the fuel retailer loyalty program server to the financial account of the user.

16. The method of claim 15, wherein the consumer device is at least one of a mobile phone, a portable computer tablet, a laptop computer, a desktop computer, or a smart television display system.

17. The method of claim 1, further comprising providing a fuel retailer fuel pump configured to communicate with, using commercially available unmodified point-of-sale hardware and software systems, at least one of the integration system server, the issuing retailer loyalty program server, and the fuel retailer loyalty program server.

18. The method of claim 17, wherein the fuel retailer fuel pump consists of commercially available unmodified point-of-sale hardware and software systems.

19. A non-transient computer readable medium containing program instructions for causing a computer to perform the method of:
operably connecting an integration system server to an integration system database;
operably connecting an issuing retailer loyalty program server to an issuing retailer loyalty program database;
facilitating communication between the issuing retailer loyalty program server and the integration system server using commercially available unmodified point-of-sale hardware and software systems;
operably connecting a fuel retailer loyalty program server to a fuel retailer loyalty program database; and
facilitating communication between the fuel retailer loyalty program server and the integration system server using commercially available unmodified point-of-sale hardware and software systems for providing interoperability of loyalty programs of an issuing retailer and a fuel retailer.

20. The non-transient computer readable medium containing program instructions for causing a computer to perform the method of claim 19, further comprising using commercially available unmodified point-of-sale hardware and software systems, facilitating communication between the integration system server and a financial account of a user so as to facilitate a transfer of a financial reward from at least one of the integration system server, the issuing retailer loyalty program server, and the fuel retailer loyalty program server to the financial account of the user.
